(19) United States
(12) Patent Application Publication
(10) Pub. No.: US 2024/0280115 A1
(43) Pub. Date: Aug. 22, 2024

(54) VACUUM PUMP

(71) Applicant: Edwards Japan Limited, Chiba (JP)

(72) Inventors: Yoshiyuki Takai, Chiba (JP); Tooru Miwata, Chiba (JP); Yoshiyuki Sakaguchi, Chiba (JP)

(21) Appl. No.: 18/571,958

(22) PCT Filed: Jul. 21, 2022
(86) PCT No.: PCT/JP2022/028323

§ 371 Date: Dec. 19, 2023

(30) Foreign Application Priority Data
Jul. 26, 2021 (JP) 2021-121199

(51) Int. Cl. F04D 29/60; F04D 19/04; F04D 29/08

(52) U.S. Cl. CPC F04D 29/601; F04D 19/04; F04D 29/083

(57) ABSTRACT

A vacuum pump includes a contact portion that contacts a jig used to adjust the height of a seal member in an axial direction. At the time of assembling the vacuum pump in which a pump fixing component is arranged opposed to the outer periphery of a rotating body, the jig is positioned by the contact portion with the pump fixing component arranged on a base, and the pump fixing component is pressed in the direction of the base by the pressing portion of the positioned jig to adjust the height of the seal member in the axial direction. The pump fixing component is entirely lowered in the direction of the base by the adjustment.

### CROSS-REFERENCE OF RELATED APPLICATION

This application is a Section 371 National Stage Application of International Application No. PCT/JP2022/028323, filed Jul. 21, 2022, which is incorporated by reference in its entirety and published as WO 2023/008302A1 on Feb. 2, 2023 and which claims priority of Japanese Application No. 2021-121199, filed Jul. 26, 2021.

### FIELD

The present invention relates to a vacuum pump used as a gas exhausting means of a process chamber or other chambers in a semiconductor manufacturing device, a flat panel display manufacturing device, and a solar panel manufacturing device, a method for manufacturing the vacuum pump, and a jig used for assembling the vacuum pump and, in particular, to a vacuum pump, a method for manufacturing the vacuum pump, and a jig suitable for supporting the assembling operation of the vacuum pump.

### BACKGROUND

As a vacuum pump of this type, a vacuum pump described in PTL 1 has been, for example, known conventionally. The vacuum pump of the literature includes a turbine stage having a structure in which stator blades (7) and rotor blades (6) are alternately arranged.

However, a conventional vacuum pump including a turbine stage like the one as described in PTL 1 has stator blades (7) interposed between rotor blades (6) adjacent to each other in a vertical direction in its structure. Therefore, at the time of the assembling operation of the vacuum pump, particularly, at the time of the operation of interposing the stator blades (7) between the rotor blades (6), the stator blades (7) and the rotor blades (6) interfere with each other, which possibly causes scratches or the like on the stator blades (7) and the rotor blades (6). Therefore, the assembling operation of the vacuum pump is troublesome.

The discussion above is merely provided for general background information and is not intended to be used as an aid in determining the scope of the claimed subject matter. The claimed subject matter is not limited to implementations that solve any or all disadvantages noted in the background.

### CITATION LIST

### Patent Literature

[PTL 1] Japanese Patent Application Laid-open No. 2014-51952

### SUMMARY

The present invention has been made in order to solve the above problem and has an object of providing a vacuum pump having a structure suitable for supporting the assembling operation of the vacuum pump, a method for assembling the vacuum pump, and a jig used for assembling the vacuum pump.

In order to achieve the above object, the present invention provides a vacuum pump including: a base; a rotating body that is arranged on the base; a supporting means for rotatably supporting the rotating body about an axis thereof; a pump fixing component that is arranged opposed to an outer periphery of the rotating body; a casing that fixes at least a part of the pump fixing component on an upper side thereof; a gap that is formed between the pump fixing component and the base; a seal member that seals the gap; and a contact portion that contacts a jig used to adjust a height of the seal member in an axial direction.

In the vacuum pump according to the present invention, the contact portion may be arranged at a same phase as an accessory component attached to the pump fixing component so that the jig positioned by the contact portion and the accessory component interfere with each other when the accessory component is attached.

Further, the present invention provides a method for assembling a vacuum pump including a base, a rotating body that is arranged on the base, a supporting means for rotatably supporting the rotating body about an axis thereof, a pump fixing component that is arranged opposed to an outer periphery of the rotating body, a casing that fixes at least a part of the pump fixing component on an upper side thereof, a gap that is formed between the pump fixing component and the base, a seal member that seals the gap, and a contact portion that contacts a jig used to adjust a height of the seal member in an axial direction, the method including as a process of arranging the pump fixing component to face the outer periphery of the rotating body: a first step of positioning the jig by the contact portion with the pump fixing component arranged on the base and pressing the pump fixing component in a direction of the base by a pressing portion of the positioned jig as a means for avoiding interference between stator blades laminated on the pump fixing component as a part of the pump fixing component and rotor blades protruding toward a direction of the pump fixing component from the outer periphery of the rotating body to perform adjustment so that the height of the seal member in the axial direction becomes a first prescribed value; a second step of arranging the stator blades on the pump fixing component after the first step to form a turbine stage having a structure in which the stator blades and the rotor blades are alternately arranged; and a third step of fixing the pump fixing component to the base by the casing after the second step to perform adjustment so that the height of the sealing member in the axial direction becomes a second prescribed value.

In the method for assembling the vacuum pump according to the present invention, the first prescribed value may be a dimension value slightly higher than a designed dimension value of the seal member, and the second prescribed value may be the designed dimension value of the seal member.

In the method for assembling the vacuum pump according to the present invention, a gap may be formed between the pressing portion of the jig used in the first step and the pump fixing component in the third step.

In addition, the present invention provides a jig used for assembling a vacuum pump including a base, a rotating body that is arranged on the base, a supporting means for rotatably supporting the rotating body about an axis thereof, a pump fixing component that is arranged opposed to an outer periphery of the rotating body, a casing that fixes at least a part of the pump fixing component on an upper side thereof, a gap that is formed between the pump fixing component and the base, a seal member that seals the gap, and a contact portion that contacts a jig used to adjust a height of the seal member in an axial direction, the jig including: a pressing portion that is positioned by the contact portion with the pump fixing component arranged on the base and presses the pump fixing component in a direction of the base in a positioned state to adjust the height of the seal member in the axial direction.

In the jig according to the present invention, the jig may be disposed inside the pump with a gap formed between the jig and the pump fixing component after adjusting the height of the seal member in the axial direction.

In the jig according to the present invention, the jig may be arranged at a same phase as an accessory component attached to the pump fixing component to interfere with the accessory component when the accessory component is attached.

According to the present invention, a vacuum pump employs as its specific configuration a contact portion that contacts a jig used to adjust the height of a seal member in an axial direction as described above. Therefore, at the time of assembling the vacuum pump, for example, when a pump fixing component is arranged opposed to the outer periphery of a rotating body, the jig is positioned by the contact portion with the pump fixing component arranged on a base, and the pump fixing component is pressed in the direction of the base by the pressing portion of the positioned jig. Thus, the height of the seal member in the axial direction is adjusted, and the pump fixing component is entirely lowered in the direction of the base by the adjustment. As a result, it is possible to avoid the interference between components, specifically, the interference between stator blades laminated on the pump fixing component as a part of the pump fixing component and rotor blades protruding toward the direction of the pump fixing component from the outer periphery of the rotating body. In this regard, the vacuum pump having a structure suitable for supporting the assembling operation of the vacuum pump may be provided.

According to the present invention, a method for assembling a vacuum pump employs first to third steps as described above. In the first step, a jig is positioned by a contact portion with a pump fixing component arranged on a base, and the pump fixing component is pressed in the direction of a base by the pressing portion of the positioned jig as a means for avoiding the interference between stator blades laminated on the pump fixing component as a part of the pump fixing component and rotor blades protruding toward the direction of the pump fixing component from the outer periphery of a rotating body to perform adjustment so that the height of a seal member in an axial direction becomes a first prescribed value. Thus, it is possible to avoid the above interference when the stator blades are arranged on the pump fixing component to form a turbine stage having a structure in which the stator blades and the rotor blades are alternately arranged after the first step. In this regard, the method for assembling the vacuum pump is suitable for supporting the assembling operation of the vacuum pump.

According to the present invention, a jig used for assembling a vacuum pump as described above employs as its specific configuration a pressing portion that is positioned by a contact portion with a pump fixing component arranged on a base and that presses the pump fixing component in the direction of a base in its positioned state to adjust the height of a seal member in an axial direction as described above. Thus, by the adjustment of the height of the seal member in the axial direction to entirely lower the pump fixing component in the direction of the base, it is possible to avoid the interference between components, specifically, the interference between stator blades laminated on the pump fixing component as a part of the pump fixing component and rotor blades protruding toward the direction of the pump fixing component from the outer periphery of a rotating body. In this regard, the jig is suitable for supporting the assembling operation of the vacuum pump.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF DRAWINGS

FIG. 1 is a vertical cross-sectional view of a vacuum pump called a turbo molecular pump;

FIG. 2 is a circuit diagram of an amplifier circuit;

FIG. 3 is a time chart showing control performed when a current command value is greater than a detected value;

FIG. 4 is a time chart showing control performed when the current command value is smaller than the detected value;

FIG. 5 is a cross-sectional view of a vacuum pump to which the present invention is applied;

FIG. 6 is an explanatory view of a first step;

FIG. 7 is an explanatory view of second and third steps;

FIG. 8 is a view showing a part of FIG. 7 and an enlargement thereof;

FIG. 9 is a schematic view of the arrangement of jigs to which the present invention is applied with respect to the vacuum pump;

FIG. 10 is a top view of a jig; and

FIG. 11 is a front view of the jig.

### DETAILED DESCRIPTION

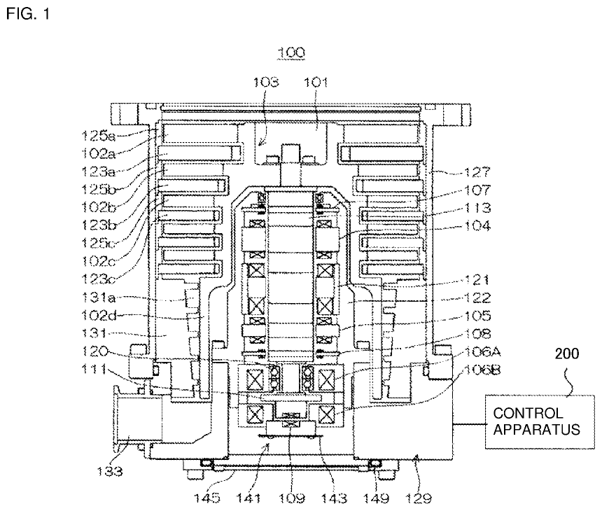

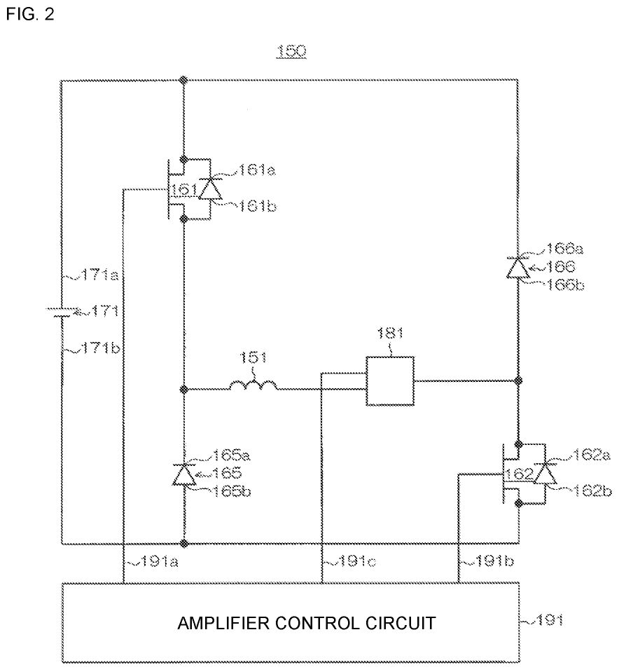

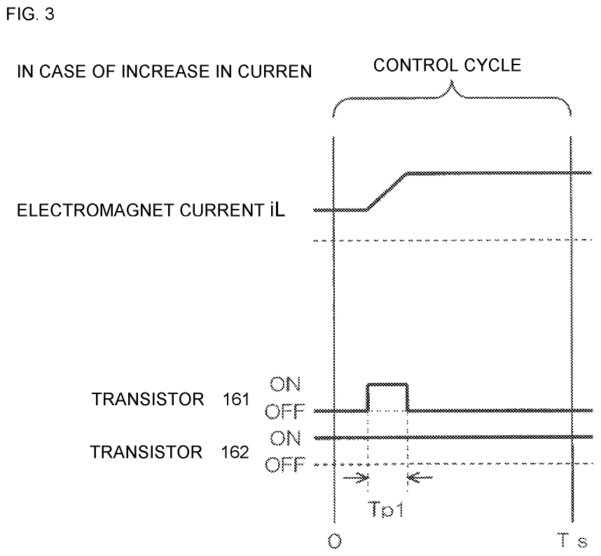

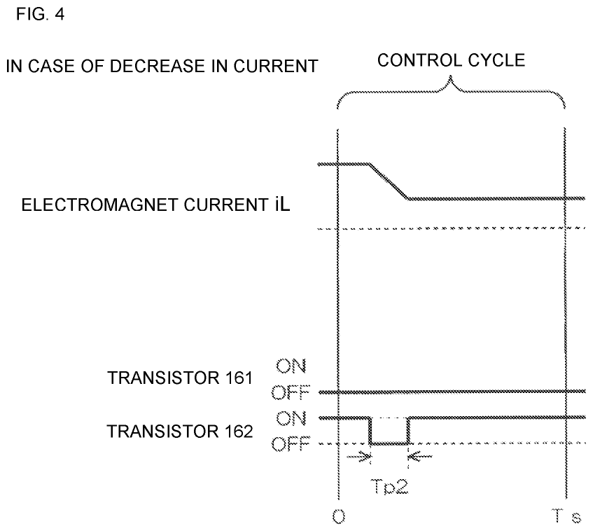

FIG. 1 is a vertical cross-sectional view of a vacuum pump called a turbo molecular pump, FIG. 2 is a circuit diagram of an amplifier circuit, FIG. 3 is a time chart showing control performed when a current command value is greater than a detected value, and FIG. 4 is a time chart showing control performed when the current command value is smaller than the detected value.

As shown in FIG. 1, a vacuum pump 100 has an inlet port 101 at the upper end of a cylindrical outer cylinder 127. Further, the vacuum pump 100 includes a rotor 103 (hereinafter called a “rotating body 103”), in which a plurality of rotor blades 102 (102a, 102b, 102c, etc.) serving as turbine blades for sucking and exhausting gas are formed at its peripheral portion radially and in multiple stages, inside the outer cylinder 127. As a specific configuration example of the rotating body 103, the rotating body 103 has the rotor blades 102 formed on the outer periphery of a first cylindrical portion 102e in the vacuum pump 100 of FIG. 1.

At the center of the rotating body 103, a rotor shaft 113 is attached via a fastening portion CN. The rotor shaft 113 is supported to be floated and position-controlled in the air by, for example, a magnetic bearing that performs five-axis control. In this case, the magnetic bearing and the rotor shaft 113 function as a supporting means for rotatably supporting the rotating body 103 about its axis. Further, the rotating body 103 is generally made of metal such as aluminum and an aluminum alloy.

As a specific configuration example of the magnetic bearing, upper radial electromagnets 104 have four electromagnets arranged in pairs in X and Y axes in the vacuum pump 100 of FIG. 1. Four upper radial sensors 107 are provided so as to be close to the upper radial electromagnets 104 and correspond to the respective upper radial electromagnets 104. Inductance sensors, eddy-current sensors, or the like having a conductive coil are, for example, used as the upper radial sensors 107. The position of the rotor shaft 113 is detected on the basis of a change in the inductance of the conductive coil that changes in accordance with the position of the rotor shaft 113. The upper radial sensors 107 are configured to detect the radial displacement of the rotor shaft 113, that is, the radial displacement of the rotating body 103 fixed to the rotor shaft 113 and transmit the detected displacement to a control device 200.

In the control device 200, for example, a compensating circuit having a PID adjusting function generates an excitation control command signal for the upper radial electromagnets 104 on the basis of a position signal detected by the upper radial sensors 107, and an amplifier circuit 150 (that will be described later) shown in FIG. 2 controls the excitation of the upper radial electromagnets 104 on the basis of the excitation control command signal. Thus, the upper radial position of the rotor shaft 113 is adjusted.

The rotor shaft 113 is made of a high permeability material (such as iron and stainless steel) or the like and sucked by the magnetic forces of the upper radial electromagnets 104. The adjustment is separately performed in each of an X-axis direction and a Y-axis direction. Further, lower radial electromagnets 105 and lower radial sensors 108 are arranged like the upper radial electromagnets 104 and the upper radial sensors 107 and adjust the lower radial position of the rotor shaft 113 like the upper radial position.

In addition, as a specific configuration example of the magnetic bearing, axial electromagnets 106A and 106B are arranged with a disc-shaped metal disc 111 at the lower portion of the rotor shaft 113 held therebetween in a vertical direction in the vacuum pump 100 of FIG. 1. The metal disc 111 is made of a high permeability material such as iron. An axial sensor 109 is provided to detect the axial displacement of the rotor shaft 113, and an axial position signal detected by the axial sensor 109 is configured to be transmitted to the control device 200.

Then, in the control device 200, for example, the compensating circuit having the PID adjusting function generates an excitation control command signal for each of the axial electromagnet 106A and the axial electromagnet 106B on the basis of the axial position signal detected by the axial sensor 109, and the amplifier circuit 150 controls the excitation of each of the axial electromagnet 106A and the axial electromagnet 106B on the basis of the excitation control command signal. Thus, the axial electromagnet 106A sucks the metal disc 111 upward by a magnetic force, and the axial electromagnet 106B sucks the metal disc 111 downward by a magnetic force, so that the axial position of the rotor shaft 113 is adjusted.

As described above, the control device 200 appropriately adjusts a magnetic force applied to the metal disc 111 by the axial electromagnets 106A and 106B and magnetically floats the rotor shaft 113 in an axial direction and retains the same in a non-contact manner in a space. Note that the amplifier circuit 150 that controls the excitation of the upper radial electromagnets 104, the lower radial electromagnets 105, and the axial electromagnets 106A and 106B will be described later.

Meanwhile, a motor 121 includes a plurality of magnetic poles circumferentially arranged so as to surround the rotor shaft 113 in the vacuum pump 100 of FIG. 1. The respective magnetic poles are controlled by the control device 200 so as to rotate and drive the rotor shaft 113 via an electromagnetic force applied between the respective magnetic poles and the rotor shaft 113. Further, a rotating speed sensor such as a hall element, a resolver, and an encoder not shown is, for example, incorporated into the motor 121, and the rotating speed of the rotor shaft 113 is detected by the detection signal of the rotating speed sensor.

In addition, a phase sensor not shown is attached near, for example, the lower radial sensors 108 and detects the phase of the rotation of the rotor shaft 113. The control device 200 detects the positions of the magnetic poles using both the detection signals of the phase sensor and the rotating speed sensor.

A plurality of stator blades 123 (123a, 123b, 123c, etc.) are disposed with a slight gap with respect to the rotor blades 102 (102a, 102b, 102c, etc.). Each of the rotor blades 102 (102a, 102b, 102c, etc.) is formed to be inclined by a prescribed angle from a plane perpendicular to the axial line of the rotor shaft 113 to transfer the molecules of exhaust gas downward by collision. The stator blades 123 (123a, 123b, 123c, etc.) are made of, for example, metal such as aluminum, iron, stainless steel, and copper or metal such as an alloy containing these metal as components.

Further, the stator blades 123 are also similarly formed to be inclined by a prescribed angle from the plane perpendicular to the axial line of the rotor shaft 113 and disposed alternately with the stages of the rotor blades 102 toward the inside of the outer cylinder 127. The outer peripheral ends of the stator blades 123 are supported in a state of being fitted and inserted between a plurality of stacked stator blade spacers 125 (125a, 125b, 125c, etc.).

The stator blade spacers 125 are ring-shaped members and made of, for example, metal such as aluminum, iron, stainless steel, and copper or metal such as an alloy containing these metal as components. On the outer periphery of the stator blade spacers 125, the outer cylinder 127 is fixed with a slight gap. A base 129 is disposed at the bottom of the outer cylinder 127. An outlet port 133 is formed on the base 129 and communicates with an outside. Exhaust gas transferred to the base 129 after entering the inlet port 101 from the side of a chamber (vacuum chamber) is supplied to the outlet port 133.

In addition, a threaded spacer 131 is disposed between the lower portion of the stator blade spacers 125 and the base 129 depending on the use of the vacuum pump 100. The threaded spacer 131 is a cylindrical member made of metal such as aluminum, copper, stainless steel, iron, and an alloy containing these metal as components and has a plurality of spiral thread grooves 131a engraved on its inner peripheral surface. The spiral direction of the thread grooves 131a is a direction in which the molecules of exhaust gas are transferred to the outlet port 133 when the molecules move in the rotating direction of the rotating body 103. A second cylindrical portion 102d suspends from a lowermost portion continuous with the rotor blades 102 (102a, 102b, 102c, etc.) of the rotating body 103 so as to be connected to the first cylindrical portion 102e. The outer peripheral surface of the second cylindrical portion 102d has a cylindrical shape, overhangs toward the inner peripheral surface of the threaded spacer 131, and comes close to the inner peripheral surface of the threaded spacer 131 with a prescribed gap. The exhaust gas transferred to the thread grooves 131a by the rotor blades 102 and the stator blades 123 is supplied to the base 129, while being guided by the thread grooves 131a.

The base 129 is a disc-shaped member constituting the base portion of the vacuum pump 100 and is generally made of metal such as iron, aluminum, and stainless steel. Since the base 129 serves also as a heat conducting path besides physically retaining the vacuum pump 100, metal such as iron, aluminum and copper having stiffness and high heat conductivity is desirably used as such.

According to the above configuration, exhaust gas is sucked from the chamber via the inlet port 101 by the operation of the rotor blades 102 and the stator blades 123 when the rotor blades 102 are rotationally driven by the motor 121 together with the rotor shaft 113. The rotor blades 102 generally have a rotating speed of 20,000 rpm to 90,000 rpm, and a peripheral speed at the tip ends of the rotor blades 102 reaches 200 m/s to 400 m/s. The exhaust gas sucked via the inlet port 101 is transferred to the base 129 after passing through between the rotor blades 102 and the stator blades 123. At this time, the temperature of the rotor blades 102 increases due to friction heat generated when the exhaust gas contacts the rotor blades 102, the conduction of heat generated by the motor 121, or the like. However, the heat is transferred to the side of the stator blades 123 through radiation or conduction by the gas molecules or the like of the exhaust gas.

The stator blade spacers 125 are bonded to each other at an outer peripheral portion and transfer heat received by the stator blades 123 from the rotor blades 102, friction heat generated when exhaust gas contacts the stator blades 123, or the like outside.

Note that the above description assumes that the threaded spacer 131 is disposed on the periphery of the cylindrical portion 102d of the rotating body 103, and that the thread grooves 131a are engraved on the inner peripheral surface of the threaded spacer 131. Contrary to this, there is also a case that thread grooves are engraved on the outer peripheral surface of the cylindrical portion 102d, and that a spacer having a cylindrical inner peripheral surface is arranged around the thread grooves.

Further, depending on the use of the vacuum pump 100, there is also a case that the surrounding area of an electrical portion including the upper radial electromagnets 104, the upper radial sensors 107, the motor 121, the lower radial electromagnets 105, the lower radial sensors 108, the axial electromagnets 106A and 106B, the axial sensor 109, or the like is covered with a stator column 122, and that the pressure inside the stator column 122 is retained at a prescribed pressure by a purge gas in order to prevent gas sucked via the inlet port 101 from entering the electrical portion.

In this case, a pipe not shown is disposed in the base 129, and a purge gas is introduced via the pipe. The introduced purge gas is delivered to the outlet port 133 via a gap between a protecting bearing 120 and the rotor shaft 113, a gap between the rotor and the stator of the motor 121, and a gap between the stator column 122 and a cylindrical portion on the inner peripheral side of the rotor blades 102.

Here, the vacuum pump 100 requires control based on the specification of a model and separately-adjusted unique parameters (for example, various characteristics corresponding to the model). In order to store the control parameters, the vacuum pump 100 includes an electronic circuit portion 141. The electronic circuit portion 141 includes electronic components such as a semiconductor memory like an EEP-ROM and a semiconductor element for accessing the semiconductor memory, a substrate 143 for mounting the electronic components, or the like. The electronic circuit portion 141 is accommodated at, for example, the lower portion of a rotating speed sensor not shown near the center of the base 129 constituting the lower portion of the vacuum pump 100, and is closed by an air-tight bottom lid 145.

Meanwhile, in a semiconductor manufacturing process, some process gases introduced into a chamber have the property of becoming solid when their pressure becomes higher than a prescribed value or when their temperature becomes lower than a prescribed value. Inside the vacuum pump 100, the pressure of exhaust gas is the lowest at the inlet port 101 and the highest at the outlet port 133. When the pressure of a process gas becomes higher than a prescribed value or when the temperature of the process gas becomes lower than a prescribed value during the transfer of the process gas from the inlet port 101 to the outlet port 133, the process gas becomes solid and adheres to and accumulates inside the vacuum pump 100.

For example, when SiCl₄ is used as a process gas in an Al etching device, it appears from a vapor pressure curve that a solid product (for example, AlCl₃) separates out and adheres to and accumulates inside the vacuum pump 100 in a low vacuum condition (from 760 Torr to 10⁻² Torr) and at a low temperature (about 20° C.). Therefore, when the precipitate of a process gas accumulates inside the vacuum pump 100, the precipitate narrows down a gas flow path of the vacuum pump, which causes a reason for a reduction in the performance of the vacuum pump 100. Further, the product described above is liable to solidify at and adhere to a high-pressure portion near the outlet port 133 or the threaded spacer 131.

Therefore, in order to solve the above problem, a heater not shown or an annular water cooled tube 149 is wound on the periphery of the base 129 or the like, and a temperature sensor (for example, a thermistor) not shown is embedded in, for example, the base 129. Then, heating is performed by the heater or cooling control is performed by the water cooled tube 149 (hereinafter called TMS (Temperature Management System)) so that the temperature of the base 129 is retained at a constant high temperature (setting temperature) on the basis of a signal from the temperature sensor.

Next, in regard to the vacuum pump 100 thus configured, the amplifier circuit 150 that controls the excitation of the upper radial electromagnets 104, the lower radial electromagnets 105, and the axial electromagnets 106A and 106B will be described. FIG. 2 shows a circuit diagram of the amplifier circuit 150.

In FIG. 2, an electromagnet coil 151 constituting the upper radial electromagnets 104 or the like has one end thereof connected to a positive electrode 171a of a power supply 171 via a transistor 161 and the other end thereof connected to a negative electrode 171b of the power supply 171 via a current detecting circuit 181 and a transistor 162. The transistors 161 and 162 are so-called power MOSFETs and have a structure in which a diode is connected between a source and a drain.

On this occasion, a cathode terminal 161a of the diode of the transistor 161 is connected to the positive electrode 171a, and an anode terminal 161b thereof is connected to one end of the electromagnet coil 151. Further, a cathode terminal 162a of the diode of the transistor 162 is connected to the current detecting circuit 181, and an anode terminal 162b thereof is connected to the negative electrode 171b.

On the other hand, a cathode terminal 165a of a diode 165 for current regeneration is connected to one end of the electromagnet coil 151, and an anode terminal 165b thereof is connected to the negative electrode 171b. Further, a cathode terminal 166a of a diode 166 for current regeneration is similarly connected to the positive electrode 171a, and an anode terminal 166b thereof is connected to the other end of the electromagnet coil 151 via the current detecting circuit 181. The current detecting circuit 181 includes, for example, a hall sensor type current sensor or an electric resistance element.

The amplifier circuit 150 thus configured corresponds to one electromagnet. Therefore, in a case in which the magnetic bearing performs five-axis control and the total number of the electromagnets 104, 105, 106A, and 106B is ten, the same amplifier circuit 150 is constituted for each of the electromagnets, and the ten amplifier circuits 150 are connected in parallel to the power supply 171.

In addition, an amplifier control circuit 191 includes, for example, a digital signal processor portion (hereinafter called a DSP portion) not shown of the control device 200. The amplifier control circuit 191 switches the ON/OFF of the transistors 161 and 162.

The amplifier control circuit 191 compares a current value (a signal reflecting the current value is called a current detecting signal 191c) detected by the current detecting circuit 181 with a prescribed current command value. Then, on the basis of a result of the comparison, the amplifier control circuit 191 determines the size (pulse width time Tp1 or Tp2) of a pulse width to be generated in a control cycle Ts showing one cycle in PWM control. Consequently, the amplifier control circuit 191 outputs gate driving signals 191a and 191b having the pulse width to the gate terminals of the transistors 161 and 162.

Note that when passing through a resonance point during the accelerating operation of the rotation of the rotating body 103 or when disturbance occurs during an operation at a constant speed, the position of the rotating body 103 is required to be controlled at a high speed and with a great force. Therefore, a high voltage of, for example, about 50 V is used as the power supply 171 so that a rapid increase (or decrease) in a current flowing through the electromagnet coil 151 is enabled. Further, a capacitor is generally connected between the positive electrode 171a and the negative electrode 171b of the power supply 171 to stabilize the power supply 171 (not shown).

In the configuration, a current (hereinafter called an electromagnet current iL) flowing through the electromagnet coil 151 increases when both the transistors 161 and 162 are turned ON, and the electromagnet current iL decreases when both the transistors 161 and 162 are turned OFF.

Further, a so-called flywheel current is retained when one of the transistors 161 and 162 is turned ON and the other thereof is turned OFF. Then, the feeding of the flywheel current to the amplifier circuit 150 as described above leads to a decrease in hysteresis loss in the amplifier circuit 150, which makes it possible to reduce the power consumption of the whole circuit. Further, the control of the transistors 161 and 162 as described above enables a reduction in high-frequency noise such as a higher harmonic wave caused in the vacuum pump 100. In addition, the measurement of the flywheel current with the current detecting circuit 181 enables the detection of the electromagnet current iL flowing through the electromagnet coil 151.

That is, when a detected current value is smaller than a current command value, the amplifier circuit 150 turns ON both the transistors 161 and 162 for a period corresponding to the pulse width time Tp1 only once in the control cycle Ts (for example, 100 μs) as shown in FIG. 3. Therefore, in the period, the electromagnet current iL increases toward a value iLmax (not shown) of the current capable of flowing through the transistors 161 and 162 from the positive electrode 171a to the negative electrode 171b.

On the other hand, when the detected current value is greater than the current command value, the amplifier circuit 150 turns OFF both the transistors 161 and 162 for a period corresponding to the pulse width time Tp2 only once in the control cycle Ts as shown in FIG. 4. Therefore, in the period, the electromagnet current iL decreases toward a value iLmin (not shown) of the current capable of being regenerated through the diodes 165 and 166 from the negative electrode 171b to the positive electrode 171a.

Then, in both cases, the amplifier circuit 150 turns ON one of the transistors 161 and 162 after the elapse of the pulse width time Tp1 or Tp2. Therefore, the flywheel current is retained in the amplifier circuit 150 in the period.

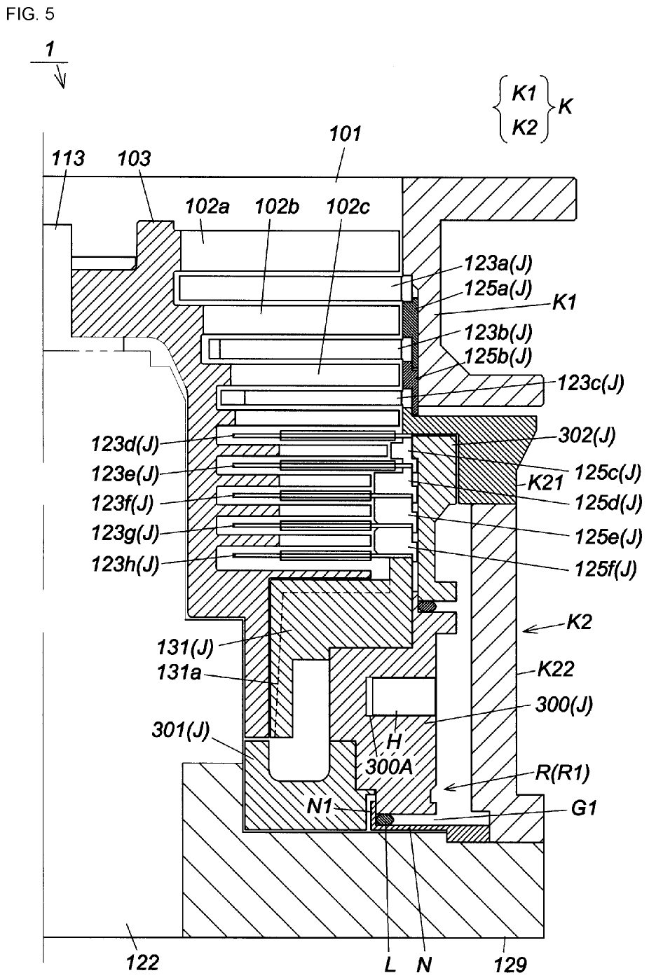

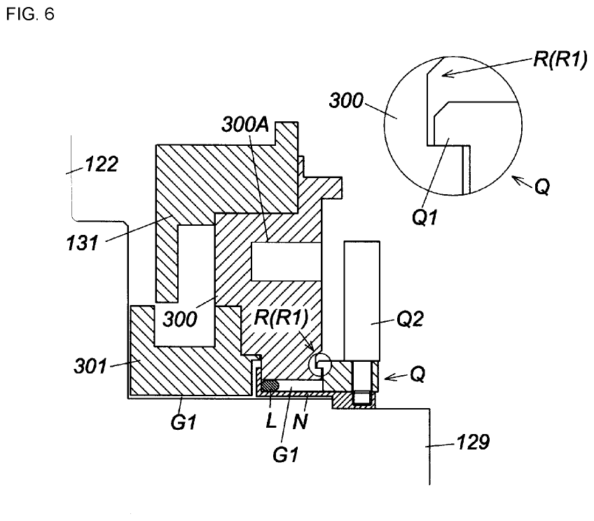

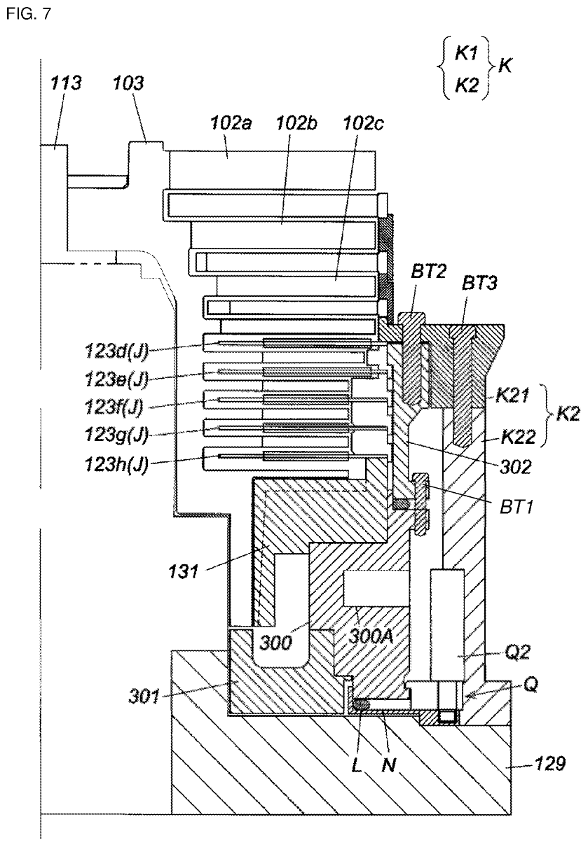

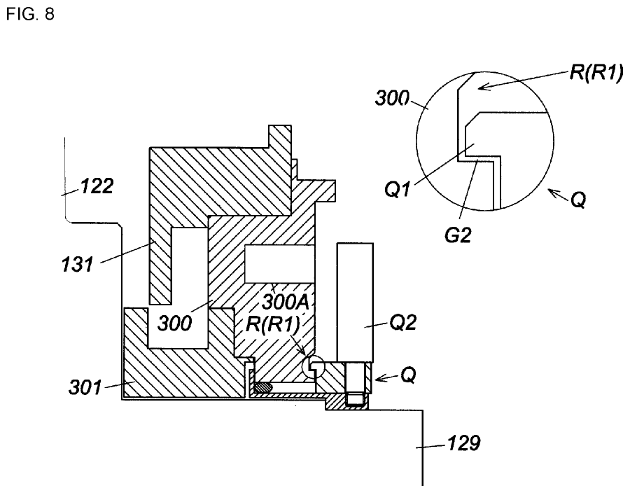

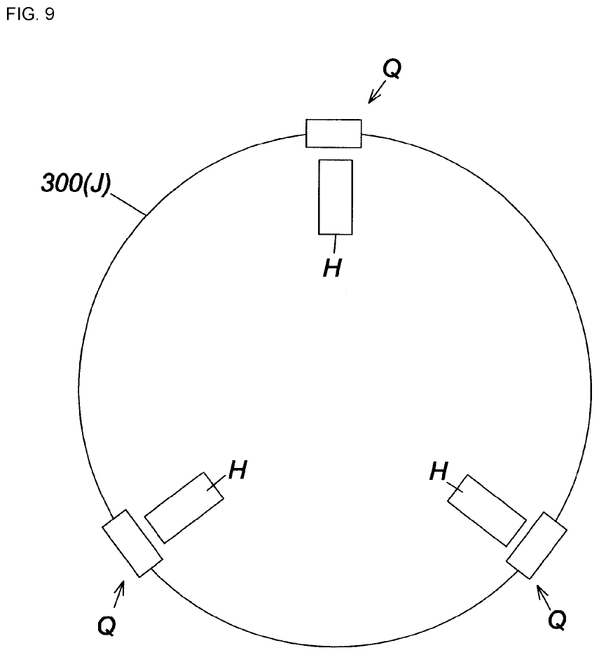

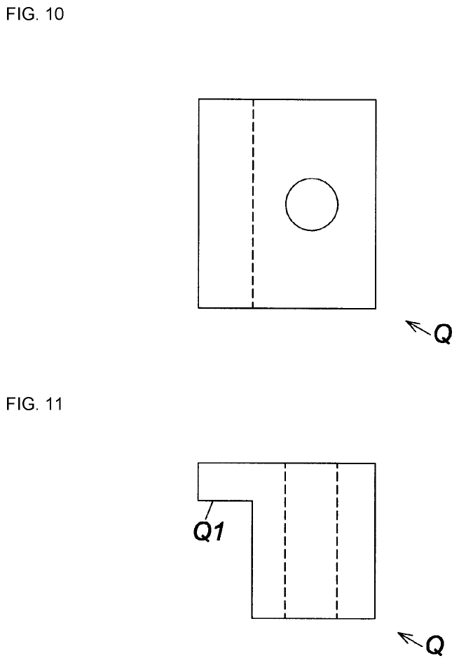

FIG. 5 is a cross-sectional view of a vacuum pump to which the present invention is applied, FIG. 6 is an explanatory view of a first step, FIG. 7 is an explanatory view of second and third steps, and FIG. 8 is a partially-enlarged view of FIG. 7. Further, FIG. 9 is a schematic view of the arrangement of jigs to which the present invention is applied with respect to the vacuum pump, FIG. 10 is a top view of a jig, and FIG. 11 is a front view of the jig.

A vacuum pump 1 of FIG. 5 includes: a base 129; a rotating body 103 arranged on the base 129; a supporting means for rotatably supporting the rotating body 103 about its axis; a pump fixing component J arranged opposed to the outer periphery of the rotating body 103; a casing K that fixes at least a part of the pump fixing component J on its upper side; a gap G1 formed between the pump fixing component J and the base 129; a seal member L that seals the gap G1; and contact portions R that contact jigs Q (see FIGS. 6 to 11) used to adjust the height of the seal member L in an axial direction.

In the vacuum pump 1 of FIG. 5, the specific configurations of the base 129, the rotating body 103, and the supporting means are the same as those of the vacuum pump 100 of FIG. 1 described above. Therefore, the same members will be denoted by the same symbols, and their detailed descriptions will be omitted.

The pump fixing component J in the vacuum pump 1 of FIG. 5 is a component arranged opposed to the outer periphery of the rotating body 103 as described above. In the vacuum pump 1 of FIG. 5, components arranged opposed to the outer periphery of the rotating body 103, specifically, at least stator blades 123 (123a, 123b, etc.), stator blade spacers 125 (125a, 125b, etc.), and a threaded spacer 131 correspond to the pump fixing component J.

In the vacuum pump 1 of FIG. 5, the specific functions of the stator blades 123, the stator blade spacers 125, and the threaded spacer 131 are the same as those of the vacuum pump 100 of FIG. 1 described above. Therefore, the same members will be denoted by the same symbols, and their detailed descriptions will be omitted.

As a specific configuration example of supporting the threaded spacer 131, the vacuum pump 1 of FIG. 5 employs a configuration in which the threaded spacer 131 is attached onto a heater spacer 300. The heater spacer 300 is also a component arranged opposed to the outer periphery of the rotating body 103 and therefore corresponds to the pump fixing component J.

The heater spacer 300 is provided with a plurality of cartridge heaters H (see FIG. 9). The cartridge heaters H function mainly as a means for heating the threaded spacer 131 by heating the heater spacer 300 to be caused to generate heat. As a structural example of attaching the cartridge heaters H to the heater spacer 300, the vacuum pump 1 of FIG. 5 employs a structure in which recessed portions 300A for heater attachment are formed on the outer periphery of the heater spacer 300 and the cartridge heaters H are attached to the recessed portions 300A. However, the vacuum pump 1 is not limited to the structure.

An insulator wall 301 is attached beneath the heater spacer 300. The insulator wall 301 functions as a means for forming an inter-pump flow path connected to an outlet port 133 (see FIG. 1) from a place near the downstream outlet of thread grooves 131a or the like. The insulator wall 301 is also a component arranged opposed to the outer periphery of the rotating body 103 and therefore corresponds to the pump fixing component J.

Further, a cylindrical inner spacer 302 is attached onto the heater spacer 300. The inner spacer 302 is arranged so as to cover the outer periphery of a laminated body (the stator blades 123 (123e to 123h) and the stator blade spacers 125 (125c to 125f) of four stages from below in the example of FIG. 5) including the stator blades 123 and the stator blade spacers 125 laminated on the threaded spacer 131. The inner spacer 302 arranged so as to cover the outer periphery of the laminated body is also a component arranged opposed to the outer periphery of the rotating body 103 and therefore corresponds to the pump fixing component J.

As a specific structural example of the contact portions R, the vacuum pump 1 of FIG. 5 employs a structure (see FIG. 6) in which recessed portions R1 are formed on the lower outer periphery of the heater spacer 300 and in which pressing portions Q1 of the jigs Q engage the recessed portions R1.

The contact portions R are used to adjust the height of the seal member L in the axial direction as described above. Therefore, it is possible to appropriately change the structure of the contact portions R where necessary without departing from the purpose. Although omitted in the figures, it is also possible to employ, for example, a structure in which the contact portions R are formed into protruding portions and the recessed portions of the jigs Q engage the protruding portions.

As a specific configuration example of the casing K, the casing K in the vacuum pump 1 of FIG. 5 is one in which the outer cylinder 127 in the vacuum pump 100 of FIG. 1 is divided into an upper casing K1 and a lower casing K2 and in which the lower casing K2 has the fixing function described above. That is, the lower casing K2 is configured to have the function of fixing at least a part of the pump fixing component J on its upper side.

The upper casing K1 functions as the housing of the vacuum pump 1. Meanwhile, the lower casing K2 has a structure in which a water cooled spacer K21 and an outer wall K22 are connected to each other by a bolt BT3 (see FIG. 7). Besides functioning as the housing of the vacuum pump 1, the lower casing K2 also functions as a means for cooling the vacuum pump 1 when a cooling medium is supplied into a water cooled tube not shown inside the water cooled spacer K21.

As a specific configuration example of fixing a part of the pump fixing component J by the lower casing K2, the vacuum pump 1 of FIG. 5 employs, in a region in which the lower casing K2 and the inner spacer 302 vertically overlap each other, a configuration in which a threaded hole is formed on the side of the inner spacer 302 while a bolt inserting hole is formed on the side of the lower casing K2 and in which a bolt BT2 (see FIG. 7) is inserted into the bolt inserting hole to be fixed to the threaded hole by fastening. However, the vacuum pump 1 is not limited to the configuration. The inner spacer 302 may be fixed by a fastening means other than the bolt BT2.

As a specific configuration example of attaching and fixing the inner spacer 302 onto the heater spacer 300, the vacuum pump 1 of FIG. 5 employs a configuration in which a threaded hole is formed on the upper flange portion of the heater spacer 300 while a bolt inserting hole is formed on the lower flange portion of the inner spacer 302 and in which a bolt BT1 (see FIG. 7) is inserted into the bolt inserting hole to be fixed to the threaded hole by fastening. However, the vacuum pump 1 is not limited to the configuration. The inner spacer 302 may be fixed by a fastening means other than the bolt BT1.

The gap G1 is provided between the upper surface of the base 129 and the lower surface of the heater spacer 300 (the pump fixing component J) adjacent and opposed to the upper surface of the base 129 and between the upper surface of the base 129 and the lower surface of the insulator wall 301 adjacent and opposed to the upper surface of the base 129 to function as a heat insulating means for preventing the transfer of heat between the base 129 and the heater spacer 300 and between the base 129 and the insulator wall 301.

In the vacuum pump of FIG. 5, the inner spacer 302, the heater spacer 300, the threaded spacer 131, the insulator wall 301, and the stator blades 123 (123e to 123h) and the stator blade spacers 125 (125c to 125f) of the four stages from below are configured to be an integrated inner unit M as a whole. In order to prevent the generation of a product inside the thread grooves 131a or the like, the inner unit M is heated by the heat generation of the heater spacer 300. The above gap G1 functions as a means for preventing the heat from being released from the inner unit M to the side of the base 129.

The seal member L is interposed in the above gap G1, that is, a place between the base 129 and the inner unit M (specifically, a place between the upper surface of the base 129 and the lower surface of the heater spacer 300) to function as a means for interrupting the inside of the vacuum pump 1 from an atmosphere side.

As a specific configuration example of interposing the seal member L in the gap G1, the vacuum pump 1 of FIG. 5 employs a configuration in which an insulator N is arranged on the base 129 and the seal member L is arranged on the insulator N. However, the vacuum pump 1 is not limited to the configuration. The insulator N may be omitted.

The insulator N partially has a rising portion N1. With the tip end of the rising portion N1 contacting the lower inner periphery of the heater spacer 300 as a contact portion and another end thereof contacting the stepped portion of the base 129, the insulator N functions as a means for positioning the heater spacer 300 in a radial direction. Further, the insulator N also functions as a means for positioning the seal member L in the radial direction when the seal member L is arranged in contact with the rising portion N1 of the insulator N.

As shown in FIG. 6, the jigs Q are positioned by the contact portions R described above with the pump fixing component J (specifically, the heater spacer 300) arranged over the base 129. The positioning of the jigs Q by the contact portions R is performed in such a manner that the pressing portions Q1 of the jigs Q engage the recessed portions R1 of the heater spacer 300 described above.

The pressing portions Q1 of the jigs Q press the pump fixing component J (specifically, the heater spacer 300) in the direction of the base 129 in a state of being positioned as described above to function as means for adjusting the height of the seal member L in the axial direction.

As a specific arrangement configuration example of the contact portions R, the contact portions R are arranged at the same phases as accessory components (the cartridge heaters H in the examples of FIGS. 5 and 9) attached to the pump fixing component J in the vacuum pump 1 of FIG. 5 as shown in FIG. 9.

Accordingly, the jigs Q positioned by the contact portions R interfere with the cartridge heaters H in the attachment of the cartridge heaters H serving as accessory components. The attachment of the cartridge heaters H is not enabled unless the jigs Q are removed, which makes it possible to effectively prevent the jigs Q from being left.

The cartridge heaters H are an example of accessory components. The jigs Q may be configured to interfere with accessory components other than the cartridge heaters H.

In the assembling of the vacuum pump 1 of FIG. 5, the rotating body 103 is arranged on the base 129, and then the pump fixing component J is arranged opposed to the outer periphery of the rotating body 103. Here, in the arrangement of the pump fixing component J, the inner spacer 302, the heater spacer 300, and the threaded spacer 131 are arranged on the base 129 as shown in FIG. 6. The arrangement operation of the pump fixing component J includes the following first to third steps.

### First Step

As shown in FIG. 6, the insulator N is first attached onto the base 129, and the seal member L is arranged on the attached insulator N in the first step. Then, the insulator wall 301, the heater spacer 300, and the threaded spacer 131 are arranged on the base 129 so as to be laminated in this order.

Thus, the insulator wall 301, the heater spacer 300, and the threaded spacer 131 are arranged opposed to the outer periphery of the rotating body 103 (the rotating body 103 shown in FIG. 5 is omitted for convenience in FIG. 6).

As described above, the insulator wall 301, the heater spacer 300, and the threaded spacer 131 are arranged opposed to the outer periphery of the rotating body 103, and the lower surface of the heater spacer 300 contacts the seal member L. Due to the thickness of the seal member L, the prescribed gap G1 is formed between the base 129 and the insulator wall 301 and between the base 129 and the heater spacer 300. Further, the heater spacer 300, the inner spacer 302, and the threaded spacer 131 are positioned in the radial direction when the lower inner periphery of the heater spacer 300 contacts the tip end of the rising portion N1 of the insulator N.

At this stage, the operation of alternately laminating the stator blades 123 and the stator blade spacers 125 on the heater spacer 300 to arrange the stator blades 123 on the pump fixing component J is not possible. Briefly, this is because the stator blades 123 laminated on the pump fixing component J as a part of the pump fixing component J interfere with the rotor blades 102 protruding toward the pump fixing component J from the outer periphery of the rotating body 103.

Therefore, in the first step, the jigs Q are arranged on the outer periphery of the heater spacer 300 with the insulator wall 301, the heater spacer 300, and the threaded spacer 131 arranged on the base 129 as described above, and the height of the jigs Q is positioned by the contact portions R of the heater spacer 300. In the positioning, the pressing portions Q1 of the jigs Q are fitted into the recessed portions R1 of the heater spacer 300.

Then, the heater spacer 300 is pressed in the direction of the base 129 by the pressing portions Q1 of the jigs Q positioned as described above to perform adjustment so that the height of the seal member L in the axial direction becomes a first prescribed value. The first prescribed value is a dimension value slightly higher than the designed dimension value of the seal member L. The above pressing may be performed using handles Q2 of the jigs Q.

The insulator wall 301, the heater spacer 300, and the threaded spacer 131 are entirely lowered in the direction of the base 129 by the pressing, which makes it possible to avoid the interference between the stator blades 123 and the rotor blades 102 described above and alternately laminate the stator blades 123 and the stator blade spacers 125 on the heater spacer 300 to arrange the stator blades 123 on the pump fixing component J.

### Second Step

In the second step, the stator blades 123 (123d to 123h) are arranged on the pump fixing component J (see FIG. 7) after the first step to form a turbine stage having a structure in which the stator blades 123 and the rotor blades 102 are alternately arranged.

In the arrangement of the stator blades 123 on the pump fixing component J, the stator blades 123 (123e to 123h) and the stator blade spacers 125 (125c to 125f) of the four stages from below are alternately laminated on the heater spacer 300 in FIG. 7.

After the stator blades 123 and the stator blade spacers 125 are laminated as described above, the inner spacer 302 is attached and fixed by the bolt BT2 so as to cover the outer periphery of a laminated body (see FIG. 7) to fix the laminated body (the stator blades 123 and the stator blade spacers 125) in the axial direction in the second step.

### Third Step

As shown in FIG. 7, the casing K is arranged on the base 129, the pump fixing component J is fixed to the base 129 by the casing K arranged, and the seal member L is further pressed in the direction of the base 129 by the force of the fixation after the second step to perform adjustment so that the height of the seal member L in the axial direction becomes a second prescribed value in the third step. The second prescribed value is the designed dimension value of the seal member L.

In the third step, “the casing K is arranged on the base 129” specifically refers to the step of screwing and fixing the lower casing K2 onto the base 129 by a bolt not shown. Further, “the pump fixing component J is fixed to the base 129 by the casing K” specifically refers to the step of connecting and fixing the lower casing K2 and the inner spacer 302 to each other by the bolt BT2. Then, the seal member L is compressed by fastening the bolt BT2 to perform adjustment so that the height of the seal member L in the axial direction becomes the designed dimension value (second prescribed value).

Further, as shown in FIG. 8, a prescribed gap G2 is formed between the pressing portions Q1 of the jigs Q used in the first step and the pump fixing component J (specifically, the contact portions R of the heater spacer 300) in the third step, which makes it possible to remove the jigs Q later.

### Last Step

In the last step, the operation of completing the turbine stage described above, that is, the operation of alternately laminating the stator blades 123 of three stages and the stator blade spacers 125 of two stages from above in FIG. 5 is performed after the third step. Then, the upper casing K1 is arranged on the outer periphery of the turbine stage, and the arranged upper casing K1 and lower casing K2 are connected to each other by a bolt not shown. Thus, the basic assembling operation of the vacuum pump is completed.

### Other Embodiments

In FIG. 5, the jigs Q described above are removed from the vacuum pump 1. As another embodiment, the jigs Q may be disposed to remain inside the vacuum pump 1 with the gap G2 formed between the jigs Q and the pump fixing component J after adjusting the the height of seal member L in the axial direction.

Specifically, instead of the handles Q2 of the jigs Q shown in the figures, bolts having a length so as not to interfere with the cartridge heaters H are used when the cartridge heaters H serving as accessory components are attached. Thus, it is possible to complete the assembling operation of the vacuum pump without removing the jigs Q.

In a case in which the jigs Q remain inside the vacuum pump 1 as described above, the reassembling of the vacuum pump with the reuse of the jigs Q or the like is enabled at the time of the overhaul or the like of the vacuum pump 1, which carries the advantage that the convenience of the assembling operation is improved.

The vacuum pump 1 of the present embodiment described above employs as its specific configuration the contact portions R that contact the jigs Q used to adjust the height of the seal member L in the axial direction. Therefore, at the time of assembling the vacuum pump, for example, when the pump fixing component J is arranged opposed to the outer periphery of the rotating body 103, the jigs Q are positioned by the contact portions R with the pump fixing component J arranged on the base 129, and the pump fixing component J is pressed in the direction of the base 129 by the pressing portions Q1 of the positioned jigs Q. Thus, the height of the seal member L in the axial direction is adjusted, and the pump fixing component J is entirely lowered in the direction of the base 129 by the adjustment. As a result, it is possible to avoid the interference between components, specifically, the interference between the stator blades 123 laminated on the pump fixing component J as a part of the pump fixing component J and the rotor blades 102 protruding toward the direction of the pump fixing component J from the outer periphery of the rotating body 103. In this regard, the vacuum pump 1 of the present embodiment is suitable for supporting the assembling operation of the vacuum pump.

Further, the method for assembling the vacuum pump of the present embodiment employs the first to third steps as described above. In the first step, the jigs Q are positioned by the contact portions R with the pump fixing component J arranged on the base 129, and the pump fixing component J is pressed in the direction of the base 129 by the pressing portions Q1 of the positioned jigs Q as a means for avoiding the interference between the stator blades 123 laminated on the pump fixing component J as a part of the pump fixing component J and the rotor blades 102 protruding toward the direction of the pump fixing component J from the outer periphery of the rotating body 103 to perform adjustment so that the height of the seal member L in the axial direction becomes the first prescribed value. Thus, it is possible to avoid the above interference when the stator blades 123 are arranged on the pump fixing component J to form the turbine stage having the structure in which the stator blades 123 and the rotor blades 102 are alternately arranged after the first step. In this regard, the method for assembling the vacuum pump of the present embodiment is suitable for supporting the assembling operation of the vacuum pump.

The jigs Q of the present embodiment employ as their specific configuration the pressing portions Q1 that are positioned by the contact portions R with the pump fixing component J arranged on the base 129 and that press the pump fixing component J in the direction of the base 129 in their positioned state to adjust the height of the seal member L in the axial direction as described above. Thus, by the adjustment of the height of the seal member L in the axial direction to entirely lower the pump fixing component J in the direction of the base 129, it is possible to avoid the interference between components, specifically, the interference between the stator blades 123 laminated on the pump fixing component J as a part of the pump fixing component J and the rotor blades 102 protruding toward the direction of the pump fixing component J from the outer periphery of the rotating body 103. In this regard, the jigs Q are suitable for supporting the assembling operation of the vacuum pump.

Note that the respective embodiments and the respective modified examples of the present invention may be combined together where necessary.

The present invention is not limited to the embodiments described above, and various modifications are made possible by the ordinary creativity of persons skilled in the art within the range of the technical idea of the present invention.

1. A vacuum pump comprising:
a base;
a rotating body that is arranged on the base;
a supporting means for rotatably supporting the rotating body about an axis thereof;
a pump fixing component that is arranged opposed to an outer periphery of the rotating body;
a casing that fixes at least a part of the pump fixing component on an upper side thereof;
a gap that is formed between the pump fixing component and the base;
a seal member that seals the gap; and
a contact portion that contacts a jig used to adjust a height of the seal member in an axial direction.

2. The vacuum pump according to claim 1, wherein
the contact portion is arranged at a same phase as an accessory component attached to the pump fixing component so that the jig positioned by the contact portion and the accessory component interfere with each other when the accessory component is attached.

3. A method for assembling a vacuum pump including a base,
a rotating body that is arranged on the base,
a supporting means for rotatably supporting the rotating body about an axis thereof,
a pump fixing component that is arranged opposed to an outer periphery of the rotating body,
a casing that fixes at least a part of the pump fixing component on an upper side thereof,
a gap that is formed between the pump fixing component and the base,
a seal member that seals the gap, and
a contact portion that contacts a jig used to adjust a height of the seal member in an axial direction,
the method comprising as a process of arranging the pump fixing component to face the outer periphery of the rotating body:
a first step of positioning the jig by the contact portion with the pump fixing component arranged on the base and pressing the pump fixing component in a direction of the base by a pressing portion of the positioned jig as a means for avoiding interference between stator blades laminated on the pump fixing component as a part of the pump fixing component and rotor blades protruding toward a direction of the pump fixing component from the outer periphery of the rotating body to perform adjustment so that the height of the seal member in the axial direction becomes a first prescribed value;
a second step of arranging the stator blades on the pump fixing component after the first step to form a turbine stage having a structure in which the stator blades and the rotor blades are alternately arranged; and
a third step of fixing the pump fixing component to the base by the casing after the second step to perform adjustment so that the height of the sealing member in the axial direction becomes a second prescribed value.

4. The method for assembling the vacuum pump according to claim 3, wherein
the first prescribed value is a dimension value slightly higher than a designed dimension value of the seal member, and
the second prescribed value is the designed dimension value of the seal member.

5. The method for assembling the vacuum pump according to claim 3, wherein
a gap is formed between the pressing portion of the jig used in the first step and the pump fixing component in the third step.

6. A jig used for assembling a vacuum pump including a base,
a rotating body that is arranged on the base,
a supporting means for rotatably supporting the rotating body about an axis thereof,
a pump fixing component that is arranged opposed to an outer periphery of the rotating body,
a casing that fixes at least a part of the pump fixing component on an upper side thereof,
a gap that is formed between the pump fixing component and the base,
a seal member that seals the gap, and
a contact portion that contacts a jig used to adjust a height of the seal member in an axial direction,
the jig comprising:
a pressing portion that is positioned by the contact portion with the pump fixing component arranged on the base and presses the pump fixing component in a direction of the base in a positioned state to adjust the height of the seal member in the axial direction.

7. The jig according to claim 6, wherein
the jig is disposed inside the pump with a gap formed between the jig and the pump fixing component after adjusting the height of the seal member in the axial direction.

8. The jig according to claim 6, wherein
the jig is arranged at a same phase as an accessory component attached to the pump fixing component to interfere with the accessory component when the accessory component is attached.
